(19) United States
(12) Patent Application Publication
(10) Pub. No.: US 2006/0026044 A1
(43) Pub. Date: Feb. 2, 2006

(54) Electronic content insurance system

(76) Inventor: Donald X. Smith II, Corvallis, OR (US)

Correspondence Address: HEWLETT-PACKARD COMPANY;Intellectual Property Administration, P. O. Box 272400, Fort Collins, CO, 80527-2400, US

(21) Appl. No.: 10/902,663

(22) Filed: Jul. 28, 2004

(51) Int. Cl. G06Q 40/00

(52) U.S. Cl. 705/4

(57) ABSTRACT

A method of managing risk in an electronic content insurance system includes an electronic actuarial agent detecting a risk factor present in a computing environment. The method continues with the electronic actuarial agent assigning a probability that the risk factor will be a cause of a loss of a content object stored in the computing environment, and the electronic actuarial agent performing one of notifying a user of the computing environment of the risk factor and acting to mitigate the risk factor.

### BACKGROUND OF THE INVENTION

As computerized equipment, including desktop and portable computing devices, digital entertainment devices, digital cameras, and processor-based communication devices becomes more and more pervasive, the amount of data under the care of the typical computer user continues to increase. For instance, in the 1980s, the average user may have owned only a few compact disc (CD) audio recordings and perhaps a handful of general-purpose “floppy” diskettes containing other data. In the 1990s, the average user continued to accumulate audio recordings on compact discs, and began storing photographs and video content on laptop and desktop computer hard drives. In the current decade, these trends continue as videocassette recorders are replaced by digital versatile disc (DVD) recorders and analog cameras are replaced by their digital counterparts. As these technologies progress into the future, users can expect to find themselves having to manage ever-increasing amounts of digital data.

Although the quality of digital storage media continues to improve, these media are nonetheless subject to catastrophic failure. For example, CDs and DVDs containing a user's favorite audio recordings or movies can become scratched from wear and rough handling. In another example, the hard disk of a desktop or a laptop computer can experience a “head crash” or other mechanical failure that renders the disk inoperative. In a further example, the integrity of the data stored on a laptop or desktop computer hard drive can become compromised due to the infection of the computer system by a virus or other malicious software. Finally, flash memory cards used in digital cameras, which may store all the of the user's pictures of his or her most recent vacation, can become lost or misplaced when the user returns home.

A popular approach toward preserving digital data involves a user storing single copies of compact discs (CDs), digital versatile discs (DVDs), and digital camera flash memory cards in a safe place. A more advanced user might occasionally back up the hard drive of a laptop or desktop computer, when the user remembers to do so. However, even though the computing industry regularly extols the virtues of backing up important digital data, many users do not take the time to back up their digital data. These users simply hope that the integrity of their digital media will never be compromised, and that they will be one of the “lucky” ones who never experience a significant loss of irreplaceable digital data.

### BRIEF DESCRIPTION OF THE DRAWINGS

FIG. 1 is a block diagram of an electronic content insurance system according to an embodiment of the invention.

FIG. 2 is a block diagram of an electronic actuarial agent used in the electronic content insurance system of FIG. 1 according to an embodiment of the invention.

FIG. 3 is a flowchart of a method of managing risk in an electronic content insurance system according to an embodiment of the invention.

### DESCRIPTION OF THE EMBODIMENTS

An electronic content insurance system provides a means of preserving content stored at various locations within a user's computing environment. In the context of the present invention, the term “content” is intended to mean electronic information that has value to a user. Thus, content may include commercially-produced electronic information such as audio recordings, movies, electronic games, software packages, and other electronically encoded information. Content can also include personally-produced information, such as digital photographs and home movies recorded by way of a digital camcorder. Content can also include electronic information that represents both commercially-produced and personally-produced information. An example of such content can be a music compilation or “mix CD” in which the user has spent time and effort arranging and perhaps modifying various commercially-produced audio recordings. An individual element of content, or content object, may range from an electronic business card consisting of only a few hundred bytes of data to a large software package consisting of many gigabytes of information.

In the context of the present invention, the term “loss” implies damage to the media that stores a content object to the extent that the content object cannot be recovered. Thus, “loss” can imply damage to a computer hard drive that renders the content objects stored on the drive as unrecoverable. Loss can also include corruption of the drive by a virus. Loss can also imply damage to an individual CD, DVD, or other commercially-produced media that renders the media unplayable in a CD or DVD player.

Embodiments of the present invention may include hardware or software modules that interface with peer computing, digital entertainment, storage, and other processor-based devices within a user's computing environment. This allows the back up and the secure storage of the user's content, while requiring only minimal user involvement. Risk factors that increase the probability of a loss of content can be identified and mitigated, either automatically and without user involvement, or by way of identifying the risk factor to the user so that the user can take corrective action. Additionally, as new components are introduced into the computing environment, the content stored on the new components can be automatically discovered and stored in a more secure location. Further, in the event that one or more of the content storage devices associated with each of the components of the computing environment does experience a loss of content, the system provides for the reimbursement of at least the value of the commercially-provided content.

Embodiments of the invention also include a content insurance provider that replaces commercially-produced content in the event of damage to the CDs and DVDs that store the user's audio recordings, games, and movies. When the user takes corrective action to mitigate a detected risk factor and thus lower the probability of a loss of content, the content insurance provider can, in turn, lower the premium paid by the user. Alternatively, the user may choose to insure previously uninsured content for the same premium. In either case, the user is motivated to take measures to reduce the risk of a loss of content upon being notified that a risk factor has been detected. Consequently, the content insurance provider and the user have fewer claim-related transactions to prosecute.

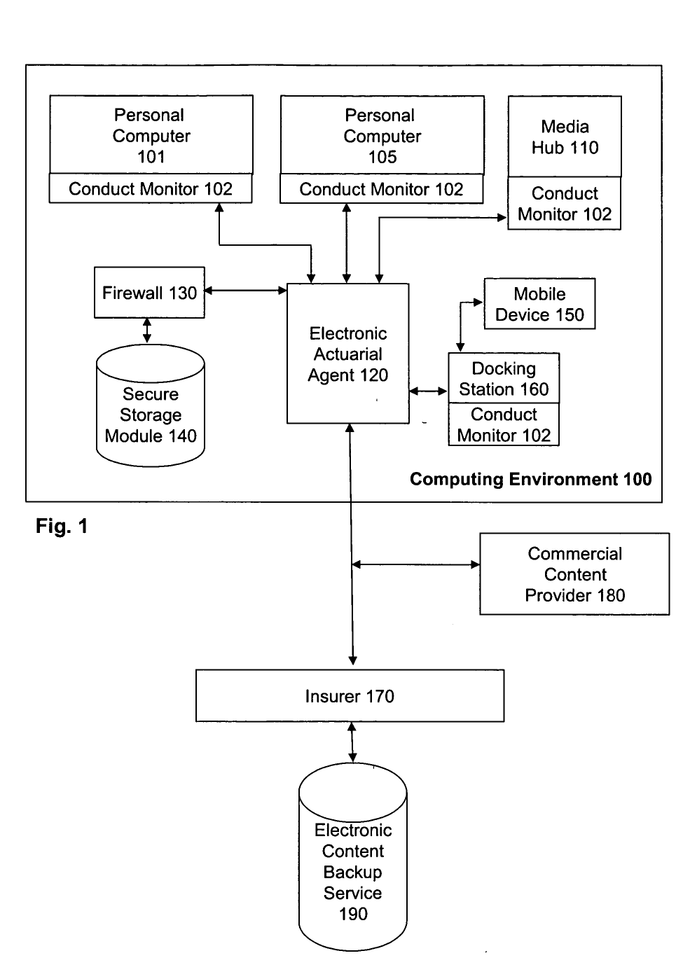

FIG. 1 is a block diagram of an electronic content insurance system according to an embodiment of the invention. In FIG. 1, computing environment 100 represents a user's home network of computing, entertainment, and communications devices, each of which store content objects. Personal computer 101 and personal computer 105 may represent desktop, laptop, or handheld computing devices located in various rooms of a user's house or other dwelling. Media hub 110 represents a storage facility in which a user may store one or more DVDs, CDs, or other commercially-produced content. Docking station 160 represents a facility that accepts mobile device 150 and is primarily responsible for removing or copying content stored on the mobile device. In FIG. 1, mobile device 150 may represent the user's camera-equipped cellular telephone, digital camera, or portable solid-state audio device, such as an iPod™.

At least occasionally coupled to personal computer 101, personal computer 105, media hub 110, and docking station 160, is electronic actuarial agent 120. Electronic actuarial agent 120 is contemplated as including both hardware and software modules that establish a communications path with components of the user's computing environment and automatically discover if new content has been stored on the particular component. Thus, for example, in the event that the user has just returned from vacation, the user may place a digital camera loaded with vacation pictures atop docking station 160, thus enabling electronic actuarial agent 120 to remove digital pictures and digital movie clips from the camera and store these in secure storage module 140. In another example, if the user has just purchased music from an on-line music store, electronic actuarial agent 120 may detect and automatically back up the recently-purchased music. In the event that content objects stored within the user's computing environment are lost, insurer 170 can contact commercial content provider 180 so that the lost content objects can be replaced or the user can be reimbursed for the replacement value of the lost content objects. In the context of the present invention, the term “commercial content provider” may include the content distributor, the content owner, such as Disney for example, or any other business entity that sells, distributes, or licenses commercially-available content.

In other embodiments of the invention, electronic actuarial agent 120 may not take such an active role in moving or copying content to and from the various locations within computing environment 100. In these embodiments, electronic actuarial agent 120 performs more of a managerial role in which various components in the computing environment are directed to perform specific tasks, rather than those tasks being performed exclusively by actuarial agent 120.

Returning to the embodiment of FIG. 1, when new content has been detected within the computing environment, the decision as to whether or not to back up the content can be a function of the file type of the detected content, with certain file types being considered more valuable than others. Thus, in the event that content in the form of digital pictures has been detected, the user may wish to immediately and automatically move or copy these content objects to a secure storage device. In this case, all digital pictures may be assigned a certain value indicator by electronic actuarial agent 120 and backed up accordingly. In other cases, the user may assign a value indicator to the various individual pictures so that important pictures, as designated by the user, can be backed up immediately while less important content objects are backed up later, or not at all. In this embodiment, other types of content objects, such as contact information from a user's cellular telephone may represent another example of low-value content that the user does not wish to have immediately backed up, if at all. For still other content objects, such as commercially-produced DVD movies, a commercial content provider may be queried so that the monetary value of the purchased content can be determined and the content insurance premium can be calculated. In this example, the commercially-produced DVD movies are not backed up, although a record of the user's purchase of the movie is recorded by insurer 170.

In addition to immediately storing content objects into secure storage module 140 so that this content can be readily available to the user, electronic content backup service 190 can provide secure storage of hard-to-replace content objects. In the embodiment of FIG. 1, secure storage module 140, behind firewall 130, represents a local server that is the least vulnerable to content loss than perhaps all of the components in the user's computing environment. Thus, for example, secure storage module 140 may be physically located in the most secure area of the user's house and run the most robust virus protection software as well as having other fault tolerant attributes.

For longer term content storage, which may imply years or even decades, electronic content backup service 190 provides an offsite content storage facility. Electronic content backup service 190 may employ one or more redundant arrays of inexpensive disks (RAIDs) in order to provide highly reliable mass storage of the user's older and scarcer content. The content backup service can also include an automatic format upgrade service wherein content objects stored in older formats, such as photographs stored in older versions of the JPEG (Joint Photographic Experts Group) standard, are automatically copied to a newer JPEG standard or other future image format. This ensures that content objects are stored both in their original format as well as being stored in a current and widely-accepted standard.

In the embodiment of FIG. 1, it is contemplated that electronic actuarial agent 120 communicates with the various other components of the user's computing environment by way of wireless interfaces. Thus, computers 101 and 105, for example, may be moved to other locations within the user's home without requiring a wired connection to electronic actuarial agent 120. It is additionally contemplated that electronic actuarial agent 120 is capable of automatically discovering components that have been newly added to computing environment 100.

In FIG. 1, electronic actuarial agent 120 occasionally or periodically evaluates the usage pattern of various components in the computing environment to identify ways of reducing the risk that a given component will experience a hardware or software failure that could result in the loss of one or more content objects. Thus, for example, in the event that the user is in the habit of leaving personal computer 101 running without executing any processing tasks, electronic actuarial agent 120 may suggest to the user that the computer's hard drive is experiencing unnecessary wear and that perhaps computer 101 ought to be shut off more regularly, thus extending the life of the hard drive. In another example, where the user is switching computer 101 between the ON and OFF state numerous times between certain hours of the day, electronic actuarial agent 120 may recommend to the user that the computer simply be left in the ON state between these hours, and switched OFF during the remainder of the day.

Electronic actuarial agent 120 may also detect risk factors pertaining to software components that may protect against loss of content. These could include antivirus software, automatic back up software, or perhaps even disk defragmentation software that helps reduce wear on the disk components when the disk is being accessed. For example, in the event that actuarial agent 120 detects that the presence of a virus scanning software package loaded onto one or more of computers 101 and 105 could mitigate the risk of losing content stored on the computer, the actuarial agent may automatically download or otherwise import the latest virus definitions into computers 101 and 105. Additionally, electronic actuarial agent 120 may instruct one or more of the personal computers 101 and 105 to execute a virus detection program on a regular basis.

In other embodiments of the invention, electronic actuarial agent 120 may determine that one or more of the components in the computing environment is a laptop computer that is being regularly removed and returned to the user's home. Thus, due to a higher probability of the laptop computer being stolen or damaged in transit, actuarial agent 120 may prompt the user to back up the mobile device up more frequently than other components in the computing environment. More frequent backups may also be suggested for components in the computing environment that are older and perhaps less reliable than other components.

Electronic actuarial agent 120 may also consider the location of a component of the computing environment within the user's dwelling. Thus, a media hub located in the playroom, where the children in the house are allowed to play “dodge ball” may present an increased risk factor than a similar media hub placed in the living room. In a broader sense, the content insurance premium may be linked to at least some factors that determine a conventional (e.g. fire) insurance premium. For example, a user having a computing environment physically located in an older wooden building, without fire suppression sprinklers may pay a higher electronic content insurance premium than a user having a computing environment located in a more modern, concrete building.

In the embodiment of FIG. 1, it is contemplated that electronic actuarial agent 120 is flexible and able to detect a wide range of risk factors as determined by the insurer. The agent (120) generally operates in a manner that benefits both insurer 170 and the user of computing environment 100 to reduce the risk of a loss of electronic content to an acceptable level. Other exemplary considerations used in determining the risk factors that influence the electronic content insurance premium might include, but are not limited to the following:

1. The relative scarcity of commercially-produced content: This may include rare audio CDs, DVD movies, and games that may have been difficult to acquire thus are not readily available from a commercial content provider.

2. The age of the commercially-produced content: This may include older audio CDs, DVD movies, and games that are currently out-of-print and thus not readily available from a commercial content provider.

3. The previous claim history of a particular user: A user having a history of making more claims may present a higher risk than a user making fewer claims over the same period. This may include making claims in which human error is the cause of the loss of content. For example, a user having a history of dropping a laptop computer and irreparably damaging the computer's hard drive may present a higher risk when insuring additional computers within the user's computing environment.

4. The presence of an Internet firewall: A user having an Internet firewall may be expected to have fewer virus-related content losses than a user whose computing environment does not include a firewall.

5. The crime rate of the user's location: A user located in an area having a high rate of burglary, arson, or other property crime may present a higher risk than user's located in other areas.

6. The use of statistical data from a plurality of users.

As shown in FIG. 1, personal computers 101 and 105, as well as media hub 110, and docking station 160 all include conduct monitor 102. Conduct monitor 102 represents a trusted hardware or software module that monitors the compliance of a component of computing environment 100 with various risk mitigating strategies. For example, in the event that the user agrees to install a virus scanning software package so that the user's premium amount can be lowered, conduct monitor 102 verifies that, indeed, the software package has been installed. This provides a closed loop system in which the computing environment can be monitored to ensure that risk mitigating actions, as recommended by electronic actuarial agent 120 are carried out as promised by the user.

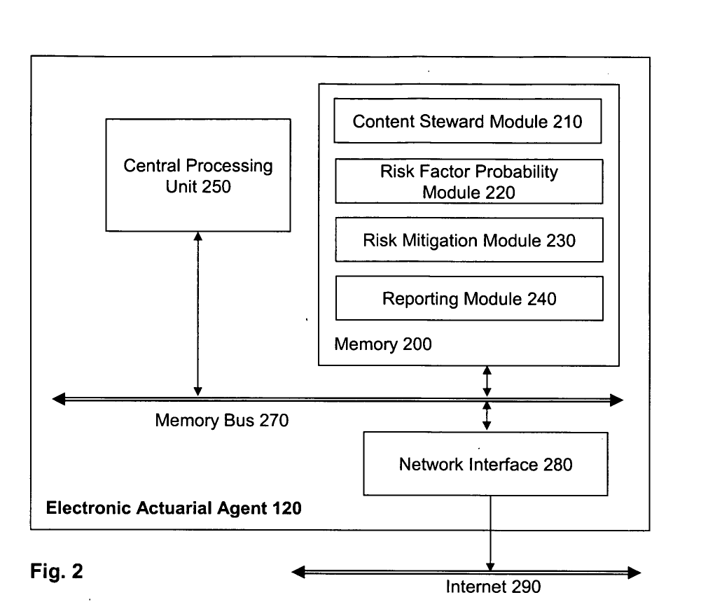

FIG. 2 is a block diagram of an electronic actuarial agent used in the electronic content insurance system of FIG. 1 according to an embodiment of the invention. In FIG. 2, electronic actuarial agent 120 includes central processing unit 250, which is coupled to memory 200 by way of memory bus 270. Memory bus 270 may be, for example, a data bus with an accompanying control/address bus. Stored within the address space of memory 200 and executable by central processing unit 105 are content steward module 210, risk factor probability module 220, risk mitigation module 230, and reporting module 240.

Content steward module 210 functions to detect risk factors in the computing environment that can contribute to a loss of content objects stored at the various locations within the computing environment. Thus, content steward module 210 maintains a list of behaviors that could be considered to be higher risk and determines if those behaviors are taking place at a particular time. For example, content steward module 210 may maintain a log of the number of hours that a particular desktop computer has been left ON without significant activity, or how many times in one day the computer has been turned OFF and then ON, or whether or not the most current version of antivirus software has been installed on the computer.

Risk factor probability module 220 functions to estimate the probability that one or more of the risk factors detected by content steward module 210 will contribute to a loss of content. Thus, for example, in the event that the user does not make use of even the most rudimentary virus scanning software, risk factor probability module 220 may assign a large probability value to reflect an outstanding likelihood that a loss of content will occur.

Risk mitigation module 230 functions to select a course of action to mitigate the risk factor based on the estimate performed by risk factor probability module 220. Thus, for those risk factors that represent a serious vulnerability to content loss, risk mitigation module 230 may automatically take action to mitigate the detected risk. For example, in the event that a critical update to the computer's virus-scanning software is needed, risk mitigation module 230 may simply contact an appropriate Internet website and download the latest virus definitions. In another example, in the event that risk mitigation module 230 detects that a back up has not been performed for some time, a back up may be immediately scheduled and executed. For other detected risk factors, such as those pertaining to the age of a component of the computing environment for example, risk mitigation module 230 may simply notify the user that the content loss insurance premium could be lowered if the user were to upgrade the hard drive of an older desktop computer with a newer and more reliable hard drive.

Reporting module 240, by way of network interface 280 that interfaces to the Internet (290), serves to report detected risk factors as well as any actions taken to mitigate these risk factors to the insurer, such as insurer 170 of FIG. 1. This allows the user's content insurance premium to be immediately adjusted in response to automatic or user-performed actions taken to mitigate a detected risk. Reporting module 240 also reports to the insurer when a loss of content has occurred so that the lost content can be identified and replaced.

In an embodiment related to those of FIGS. 1 and 2, the functions performed by electronic actuarial agent 120 can be incorporated into one or more of personal computers 100 and 105, thus eliminating the need for a separate, dedicated processing resource. In this embodiment, memory 200 (FIG. 2) is populated with software modules that are used to execute the functions performed by actuarial agent 120, along with the other, more conventional, business, personal, and/or entertainment applications executed by the personal computer.

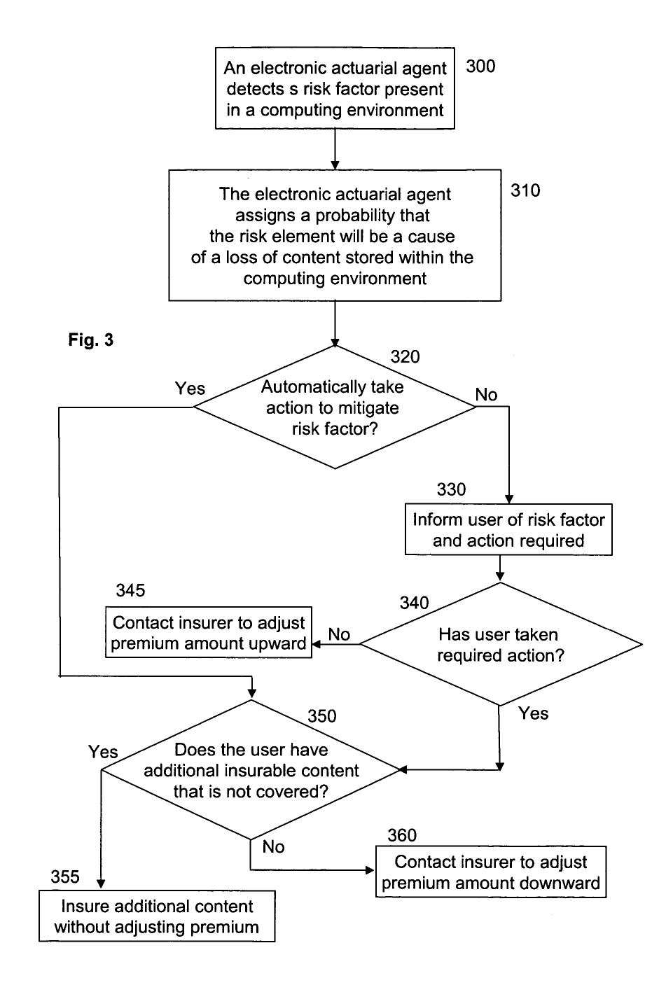

FIG. 3 is a flowchart of a method of managing risk in an electronic content insurance system according to an embodiment of the invention. The method of FIG. 3 can be practiced using the system of FIG. 1. The method of FIG. 3 begins at step 300, in which an electronic actuarial agent detects a risk factor present within a computing environment. At step 310, the electronic actuarial agent assigns a probability that the detected risk factor will be a cause of a loss of content stored within the computing environment. Step 310 can also include recalculating an electronic content insurance premium based on the detected risk factor.

At step 320, a decision is made as to whether or not to automatically take action to mitigate the detected risk. An example of an action that may be taken automatically may include downloading an update to an antivirus software package, or storing important personally-produced content in a more secure location. In the event that the decision of step 320 is that automatic action should not be taken, step 330 is performed in which the user is notified that an action to mitigate the detected risk should be taken so that the electronic content insurance premium can be reduced. At step 340, after an appropriate waiting period, a determination is made as to whether the user has taken measures to mitigate the detected risk. In the event that the user has not taken the necessary steps to mitigate the detected risk, step 345 is performed in which the insurer is informed that no action has been taken. In turn, the insurer may upwardly adjust the premium amount paid by the user.

In the event that the user has taken action to mitigate the risk, step 350 is performed in which the user selects to insure additional content not currently covered, such as recently-purchased movies, additional digital pictures, and so forth. If the user does have additional content to be insured, step 355 is performed in which the additional content is included in the electronic content insurance policy. In the event that the user does not have additional content to be insured, step 360 is performed in which the user's premium is adjusted downward.

In some embodiments of the invention, not all of steps 300 through 350 are performed. Thus, another method of managing risk in an electronic content insurance system may include an electronic actuarial agent detecting a risk factor present in a computing environment (step 300); the electronic actuarial agent assigning a probability that the risk factor will be a cause of a loss of a content object stored in the computing environment (step 310); and the electronic actuarial agent performing either step 320 in which the electronic actuarial agent automatically acts to mitigate the risk factor, or performing step 330 in which the user of the computing environment is notified of the risk factor.

While the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method of managing risk in an electronic content insurance system, comprising:
an electronic actuarial agent detecting a risk factor present in a computing environment;
the electronic actuarial agent assigning a probability that the risk factor will be a cause of a loss of a content object stored in the computing environment; and
the electronic actuarial agent performing one of notifying a user of the computing environment of the risk factor and acting to mitigate the risk factor.

2. The method of claim 1, wherein the risk factor pertains to a user behavior.

3. The method of claim 2, wherein the user behavior pertains to a need for the user to perform a corrective to mitigate the risk factor.

4. The method of claim 1, wherein the risk factor pertains to detecting a software component having reduced effectiveness and wherein the performing step further comprises the electronic actuarial agent acting to direct the importing of an additional software component.

5. The method of claim 1, wherein the performing step further comprises acting to store content objects at another location within the computing environment.

6. The method of claim 5, further comprising the electronic actuarial agent reviewing content objects that have been recently stored within the computing environment and acting to store content objects at the another location within the computing environment, based on the type of data recently stored.

7. The method of claim 5, further comprising the electronic actuarial agent assigning value to a content object.

8. The method of claim 7, wherein the assigning step is brought about by the electronic actuarial agent reading a value indicator associated with the type of content object.

9. The method of claim 7, wherein the assigning step is brought about by the electronic actuarial agent querying a commercial content provider for a monetary value of the content object.

10. The method of claim 1, additionally comprising the electronic actuarial agent changing a premium amount responsive to detecting the risk factor.

11. The method of claim 1, additionally comprising the electronic actuarial agent changing a premium amount responsive to detecting the mitigation of the risk factor.

12. The method of claim 1, additionally comprising the electronic actuarial agent insuring additional coverage without changing a premium amount.

13. An electronic actuarial agent, comprising:
a content steward module that detects one or more risk factors in a computing environment that can contribute to a loss of content objects stored within the computing environment;
a risk factor probability module that estimates a likelihood that the one or more of the risk factors will contribute to the loss of content objects stored within the computing environment; and
a risk mitigation module that selects a course of action to mitigate the risk factor based on the estimate performed by the risk factor probability module.

14. The electronic actuarial agent of claim 13, further comprising:
a reporting module that transmits information about the one or more risk factors to an insurer.

15. The electronic actuarial agent of claim 14, wherein the reporting module additionally transmits the selected course of action to mitigate the one or more risk factors to the insurer.

16. The electronic actuarial agent of claim 13, wherein the computing environment includes a plurality of content object storage locations, and wherein the type of content object stored at the plurality of locations influences the action taken by the risk mitigation module.

17. The electronic actuarial agent of claim 13, wherein the risk mitigation module acts to modify a software module running on a processor within the computing environment.

18. The electronic actuarial agent of claim 13, wherein the risk mitigation module acts to inform a user that a change in a hardware module of the computing environment can mitigate the one or more risk factors.

19. The electronic actuarial agent of claim 13, wherein the risk mitigation module acts to inform a user that an alternative to using a hardware module of the computing environment can mitigate the one or more risk factors.

20. The electronic actuarial agent of claim 13, wherein the risk factor probability module determines a change in an electronic content insurance premium based on the estimated likelihood that the one or more of risk factors will contribute to the loss of content objects stored within the computing environment.

21. The electronic actuarial agent of claim 13, wherein the one or more risks factors is selected from the group consisting of:
a usage pattern of a component of the computing environment;
the presence of a virus scanning software package on a component of the computing environment;
a version of a virus scanning software package on a component of the computing environment;
a frequency at which backups of a component of the computing environment is performed; and
the mobility of a component of the computing environment;
a measure of the scarcity of the content being insured;
a user's history of human-error induced content loss;
the presence of a firewall within the computing environment;
age of the content being insured;
age of one or more components of the computing environment;
physical location of a component of the computing environment containing the insured content;
crime rate of the area in which the computing environment is located; and
claim history of a user of the computing environment.

22. An electronic content insurance system, comprising:
a plurality of components of a computing environment, each of the plurality having a content storage device; and
an electronic actuarial agent, which is at least occasionally coupled to each of the plurality of components, for determining a level of risk that one or more of the plurality of components will experience a loss of content stored on the content storage device of each of the plurality of components.

23. The system of claim 22, wherein the electronic actuarial agent is a hardware module having a wireless connection to each of the plurality of components.

24. The system of claim 22, wherein the electronic actuarial agent is coupled to an electronic content backup service for archiving content stored on at least some of the content storage devices.

25. The system of claim 22, wherein the electronic actuarial agent includes an interface to the Internet for downloading software modules that, when run on one or more of the plurality of components, lowers the level of risk that one or more of the plurality of components will experience a loss of content.

26. The system of claim 22, wherein the electronic actuarial agent includes a user interface that prompts a user to take particular actions that reduce the level of risk that one or more of the plurality of components will experience a loss of content.

27. The system of claim 22, wherein the electronic actuarial agent examines a plurality of content objects and stores at least one of the plurality of content objects in another location within the computing environment based on a file type of the one of the plurality of content objects.

28. The system of claim 22, wherein the electronic actuarial agent influences a content insurance premium amount based on the level of risk that one or more of the plurality of components will experience a loss of content.

29. The system of claim 22, wherein the electronic actuarial agent makes use of statistical data from a plurality of users in order to determine a content insurance premium amount.

30. An electronic content insurance system, comprising:
means for coupling to a plurality of components of a computing environment, each of the plurality of components having content stored on a storage device associated with each of the plurality of components; and
means for determining a level of risk that one or more of the storage devices associated with each of the plurality of components will experience a loss of content.

31. The electronic content insurance system of claim 30, additionally comprising:
means for determining a content insurance premium based on a level of risk that one or more of the storage devices associated with each of the plurality of components will undergo a loss of content.

32. The electronic content insurance system of claim 30, additionally comprising means for performing a back up of certain data stored on at least one of the plurality of components.

33. A method insuring against a loss of content objects, comprising:
an electronic actuarial agent determining that a risk factor exists within a computing environment;
without input from a user, mitigating the risk factor; and
backing up at least some of the content objects.

34. The method of claim 33, wherein the mitigating step includes importing a version of a virus scanning software package on a component of the computing environment.
